(19) United States
(12) Patent Application Publication
(10) Pub. No.: US 2018/0285926 A1
(43) Pub. Date: Oct. 4, 2018

(54) METHOD AND APPARATUS TO ADD MODULAR MEDIA CONTENT TO SYNDICATED EMAILS

(71) Applicant: Google Inc., Mountain View, CA (US)

(72) Inventors: Michael Patrick Schneider, Venice, CA (US); Benoît de Boursetty, Santa Monica, CA (US)

(73) Assignee: Google Inc., Mountain View, CA (US)

(21) Appl. No.: 14/084,953

(22) Filed: Nov. 20, 2013

(51) Int. Cl. G06Q 30/02

(52) U.S. Cl. CPC G06Q 30/0251

(57) ABSTRACT

A messaging campaign integration system for generating a composite campaign, including integrating user created content, is disclosed herein. The composite email includes content generated for distribution to a set of end users. A content creator can specify content to be integrated in composite emails being sent to desired end users. An integration component can integrate the specified created content based on a content creator's preference. A composite email, including the specified content, can be sent to the desired end users.

### TECHNICAL FIELD

This disclosure generally relates to generating emails including integrating personalized content into digest emails based on user specific data.

### BACKGROUND

Electronic mail (hereinafter “email”) is one of the most widely used communication tools. Digest emails are often employed to summarize a corpus of communications activity (e.g., emails, notifications, alerts . . . ) association with numerous individual communications. Email digests facilitate keeping users updated on content being followed without being inundated with notifications. Digest emails can be sent to users that have affinity to a subject of the digest emails. Digest emails can be sent to a number of target users through an email campaign.

An email campaign can target desired users through user subscriptions or user enrollment in the campaign. Email campaigns can generate generic digest emails to be sent to users.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its purpose is to present some concepts of the specification in a simplified form as a prelude to the more detailed description that is presented in this disclosure.

Mail digests are periodically sent to users or subscribers of a particular service or website. In a social media context, email digests can be personalized with content based on a user's affinity to the content. For example, in a video sharing network, a user can subscribe to a channel; and an email can be generated to send to the user that features content of the subscribed to channel. A messaging campaign system can receive content, such as content exemplified above, from a plurality of content creators. The messaging campaign system can generate messages based on stored analytical information. For example, the messaging campaign system can create digest emails for users based on the respective users' affinities to certain content.

The messaging campaign system can determine a user's affinity to content based on the analytical information. For example, a user can “like,” follow, or subscribe to a content channel and/or the messaging campaign system can store the user's access history. In another aspect, the messaging campaign system can receive content created for digest messages and settings for the digest messages. The messaging campaign system can generate personalized messages utilizing the content created for the digest messages and the settings. For example, a content creator may desire that a particular video is only delivered to users within a particular age range that also have affinity to the content creator. The messaging campaign system can generate digest emails and automatically integrate personalized messages into the digest emails for users meeting the above criteria.

When a user has affinity to multiple content providers, the messaging campaign system can determine which content provider's message to integrate, where to integrate a content provider's messages, and the like. The messaging campaign system can further provide tools to assist content creators and improve quality and performance of messages. A ranking tool can employ a variety of signals to evaluate performance of text, performance of the creator's previous messaging campaigns, performance of the creator's proposed campaign in a random “canary” set of users to whom the campaign is sent first, the creator's overall brand-safety scores, and the like. An advice tool can provide content creators with determined settings and designs for messages. In an example, the determined settings and design can be predetermined (e.g., based on prior messages). A reporting tool can receive information regarding messaging statistics, such as number of messages sent, number of messages opened, number of messages clicked, and number of messages shared with others.

In another aspect, the messaging campaign system can include a pay system. The pay system can allow for various payment options. As one option, content providers can pay for campaigns based on number of emails sent, opened, or clicked. In a postpaid option, a content provider can be pilled after messages are sent, opened, or clicked. In a prepaid model, a content provider prepays a desired amount; as emails are generated, the messaging campaign system can check the content provider's balance. If the content provider's balance reaches zero or becomes negative, the messaging campaign system can halt sending of messages or finish sending the current campaign and generate a bill.

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

Numerous aspects, embodiments, objects and advantages of the present invention will be apparent upon consideration of the following detailed description, taken in conjunction with the accompanying drawings, in which like reference characters refer to like parts throughout, and in which:

FIG. 1 illustrates a block diagram of an example system that can facilitate integrating messaging campaigns and promotional campaign in accordance with certain embodiments of this disclosure;

FIG. 2 illustrates a diagram of an example system that facilitates integrating messaging campaigns and promotional campaigns into an integrated message in accordance with certain embodiments of this disclosure;

FIG. 3 illustrates a block diagram of an example system, including a console component that can provide for integrating messaging campaigns and promotional campaigns in accordance with certain embodiments of this disclosure;

FIG. 4 illustrates an example user interface that demonstrates a layout for receiving user setting associated with a campaign in accordance with various aspects and embodiments described herein;

FIG. 5 illustrates an example user interface that demonstrates a layout for receiving user content associated with a campaign and generating a preview of an integrated campaign in accordance with various aspects and embodiments described herein;

FIG. 6 illustrates a block diagram of an example system, including a reporting component, that can provide for integrating messaging campaigns and promotional campaigns in accordance with certain embodiments of this disclosure;

FIG. 7 illustrates an example schematic diagram for a computing environment configured to deliver integrated messaging campaigns in accordance with certain embodiments of this disclosure;

FIG. 8 illustrates a block diagram of an example system, including an integration component that can provide for integrating messaging campaigns and promotional campaigns in accordance with certain embodiments of this disclosure;

FIG. 9 illustrates an example methodology that can provide for integrating messaging campaigns in accordance with certain embodiments of this disclosure;

FIG. 10 illustrates an example methodology that can provide for integrating messaging campaigns, including approving or not-approving messaging campaigns, in accordance with certain embodiments of this disclosure;

FIG. 11 illustrates an example methodology that can provide for integrating messaging campaigns, including integrating emails, in accordance with certain embodiments of this disclosure;

FIG. 12 illustrates an example methodology that can provide for integrating messaging campaigns, including evaluating performance, in accordance with certain embodiments of this disclosure;

FIG. 13 illustrates an example methodology that can provide for integrating messaging campaigns, including positioning messaging campaigns, in accordance with certain embodiments of this disclosure;

FIG. 14 illustrates an example schematic block diagram for a computing environment in accordance with certain embodiments of this disclosure; and

FIG. 15 illustrates an example block diagram of a computer operable to execute certain embodiments of this disclosure.

### DETAILED DESCRIPTION

Various aspects or features of this disclosure are described with reference to the drawings, wherein like reference numerals are used to refer to like elements throughout. In this specification, numerous specific details are set forth in order to provide a thorough understanding of this disclosure. It should be understood, however, that certain aspects of disclosure may be practiced without these specific details, or with other methods, components, materials, etc. In other instances, well-known structures and devices are shown in block diagram form to facilitate describing this disclosure.

It is to be appreciated that in accordance with one or more implementations described in this disclosure, users can opt-out of providing personal information, demographic information, location information, proprietary information, sensitive information, machine information, or the like in connection with data gathering aspects. Moreover, one or more implementations described herein can provide for anonymizing collected, received, or transmitted data.

In an embodiment, a promotional campaign can comprise digest emails that are generated and sent to end users. The digest emails can be periodically generated (e.g., daily, weekly, etc.) and/or generated irregularly (e.g., sporadically). Each digest email can be sent to end users associated with content (or other identifiable data) of the digest email. An end user can be associated with the content based on affinity between the end user and the content. An affinity can be determined based on explicit data (e.g., end user subscribing to a service), implicit data (e.g., end users activity such as accessing related content), and the like. It is noted that an affinity can be determined based on one or more factors. It is appreciated that numerous methods and schemes can be utilized to determine affinity.

A digest email can contain a selection of content such as most recently added content, content identified as popular content, content created by a content creator, and the like. In an example, the digest email can comprise videos created, by a content creator, within a specified time period (e.g., most recent videos).

A content creator can provide input to a console component to generate a messaging campaign. Input can include content of a message, such as text, video, images, and the like. In another aspect, input can include targeting signals that identify a target audience of users. Targeting signals can include, for example, language, location of users, time periods, subscription states, affinity towards other content creators and/or or content, and/or user demographics (e.g., age, gender, etc.). It is noted that any suitable identifiable signal can be utilized as a targeting signal. It is further noted that targeting signals can be automatically determined and/or predefined.

A matching component can match messaging campaigns with a promotional campaign; the matching component can match targeting signals of the messaging campaigns with one or more criterion of a promotional campaign. For example, a matching component can match language of a messaging campaign to language of a promotional campaign. In another aspect, the matching component can match those messaging campaigns having content associated with the promotional campaign. For example, a promotional campaign can include a video created by a content creator and the matching campaign can match a message campaign created by the content creator.

An integration component can integrate matched messaging campaigns into appropriate promotional campaigns. For example, content of a messaging campaign can be added to a section of a promotional campaign; and the integrated campaigns can be sent to appropriate end users.

While digest emails and emails are referred to herein, any form of messaging can be utilized. For example, text messaging, instant messaging, and the like can be considered a digest message. In an aspect, a service can include providing content or access to content (e.g. video), providing access to services (e.g., social networking services, advertising services, sales services, and the like), and/or providing various other services as evident herein. In another aspect, an end user can be a user connecting, through a device, to a service. Various other aspects are described in more detail herein.

While the various components are illustrated as separate components, it is noted that the various components can be comprised of one or more other components. Further, it is noted that the embodiments can comprise additional components not shown for sake of brevity. Additionally, various aspects described herein may be performed by one device or two or more devices in communication with each other.

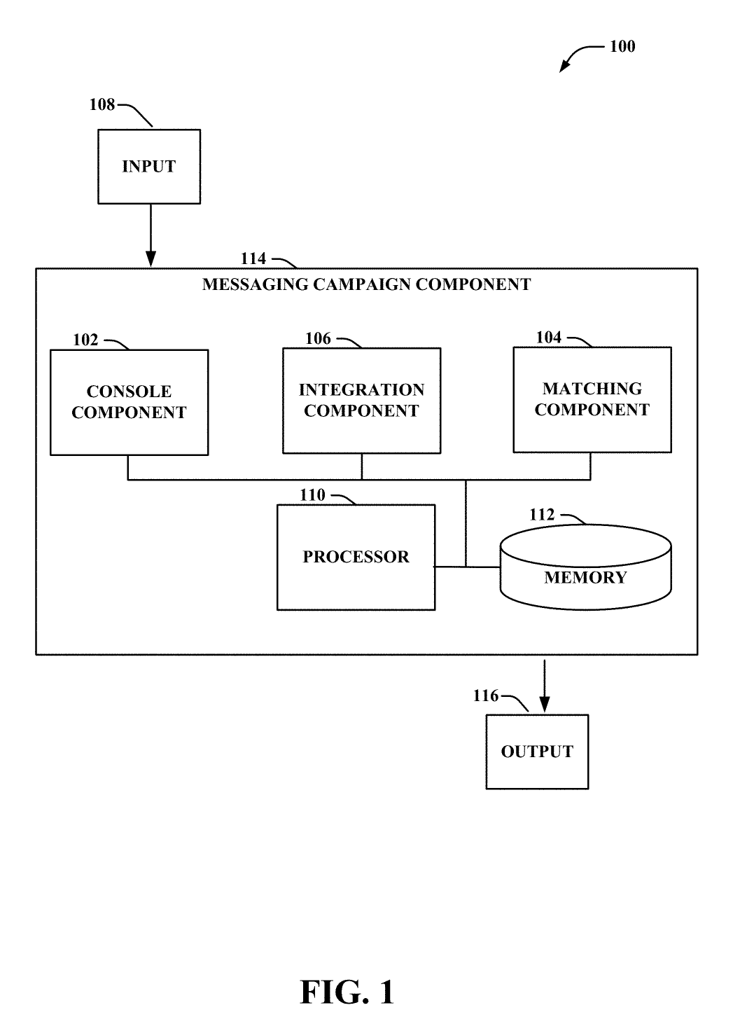

Referring now to FIG. 1, a system 100 is depicted. System 100 can, inter alia, facilitate integrating messaging campaigns and promotional campaigns. Embodiments disclosed herein can, for example, provide content creators access to consumers of their content, and increase consumer activity. As depicted, system 100 can include a messaging campaign component 114 that facilitates integration of messaging campaigns and promotional campaigns. Primary components of the messaging campaign component 114 include memory 112 that stores computer executable components and a processor 110 that executes computer executable components stored in the memory. The memory component 114 can include a console component 102 that communicates with content creators through an interface; a matching component 104 that matches campaigns for integration; and an integration component 106 that integrates campaigns and generate messages tailored for select end users. In an aspect, console component 102 can be configured to receive input 108. Input 108 can include media (e.g., audio, video, images, and the like), data associated with the media, and user input, for example. Messaging campaign component 114 can process the input and generate output 116, such as an integrated campaign.

Console component 102 can receive input associated with one or more messaging campaigns; input can include data representing a content creator's choice of settings, a message created by a content creator, and/or predetermined settings. In an embodiment, console component 102 generates a display of an interface for interactions with a content creator. The interface receives settings associated with a messaging campaign and/or content of a messaging campaign from an end user. However, it is appreciated that settings can be stored in a memory. As an example, a content creator can provide input 108 to console component 102 including a message to be sent to end users and settings describing a set of target users that the content creator desires the message to be sent to. A message can include text information, images, video, audio, and/or the like. It is noted that a message can be in any of a suitable format (e.g., hypertext markup language (HTML), rich text, plain text . . . ). In another aspect, input 108 can include data representing settings associated with a messaging campaign; settings can include information describing targeting signals, information describing context of a messaging campaign, information describing a period of the messaging campaign (e.g., start and end time of the messaging campaign). It is noted that a messaging campaign and/or various other campaigns can utilize predefined settings, such as default settings, indicating target users.

Matching component 104 can match a messaging campaign with a promotional campaign; a promotional campaign can include a digest message for end users. In an example, a promotional campaign can include a plurality of digest messages; each digest message can be generated to contain content direct towards specific end users. As an example, a digest message can contain most recent media items created by one or more content creators whom an end user has an identifiable affinity towards. It is noted that matching component 104 can determine an end user's affinity towards various aspects of a promotional campaign, such as subject of a promotional campaign, and the like-affinity, for example, can be a relationship between end users and content creator.

Matching component 104 can determine affinity as a function of explicit data, implicit data, and the like associated with an end user. Explicit data can include data indicating an end user is subscribed to a receive content created by a content creator (e.g., subscribing to a channel created associated with a content creator) and/or data indicating an end user likes content associated with the content creator (e.g., end user provided input indicating the end user likes or otherwise has an interest in content associated with the content creator), for example. Implicit data can refer to statistical data associated with an end user, such as data describing an end user's use history (e.g., end users accessing content, etc.), data describing an end user's affinity towards content related to the content creator but not created by the content creator, data describing an end user's searches, purchases, and the like. It is noted that affinity can be determined based on one or more identifiable pieces of data. It is also noted that the above provides examples of identifiable data used to determine affinity, as such virtually any suitable desired factor(s), or criteria can be utilized to determine affinity, and the desired factor(s) or criteria can depend on specific applications of embodiments described herein.

In embodiments, matching component 104 can match messaging campaigns with promotional campaigns by identifying messaging campaigns having settings that match one or more criteria of a promotional campaign. For example, matching component 104 can determine that a promotional campaign has criteria indicating a target audience of the promotional campaign. A criterion can include, for example, language type, delivery location (e.g., country of origin and/or residence of end users), affinity signals, time periods (e.g., start time and/or end time of promotional campaign), and the like. In another aspect, matching component 104 can be configured to identify messaging campaigns that are associated with content included in promotional campaigns. For example, a promotional campaign can include videos respectively created by a plurality of content creators and matching component 104 can consider those messaging campaigns created the plurality of content creators or content creators associated with the plurality of content creators. As another example, a promotional campaign can have an associated subject (e.g., wildlife, science, video games, movies, etc,) and matching component 104 can match messaging campaigns having a similar subject. It is noted that matching component 104 can match one or more messaging campaigns with one or more promotional campaigns.

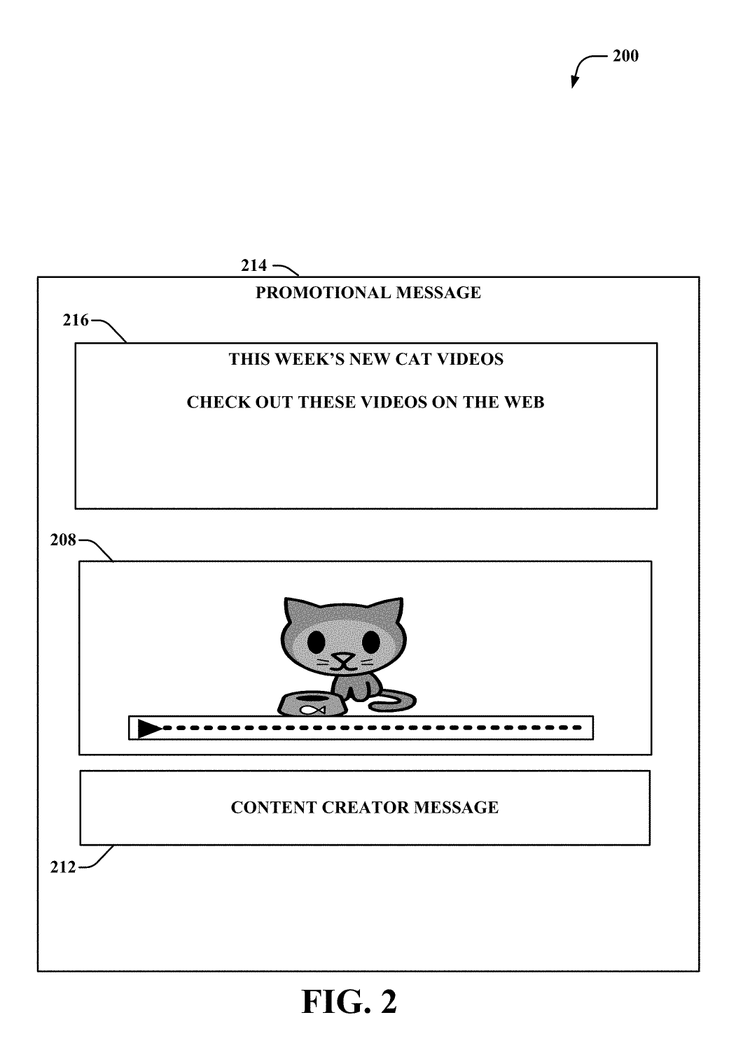

Integration component 106 can integrate messaging campaigns and promotional campaigns. In an aspect, integration component 106 can integrate content of a messaging campaign into an appropriate promotional campaign, for example, based on result(s) of matching component 104. Referring now to FIG. 2, with reference to FIG. 1, a system 200 for integrating content 208 of a message campaign and content creator's message 212 with a promotional message 214 containing digest content 216, is presented. In embodiments, a promotional message can be an email comprising digest content 216. Integration component 106 can integrate content 208 at a position in promotional message 214. In an aspect, integration component 106 can position content 208 in any determined position. It is noted that promotional message 214 need not comprise digest content 216, as depicted. For example, promotional message 214 can consist of a plurality of messages created by content creators.

In embodiments, integration component 106 can output a promotional message, such as promotional message 214. In an aspect, integration component 106 can output the promotional message by uploading, publishing, saving, presenting (e.g., streaming, broadcasting, transmitting, downloading, and/or displaying), or otherwise distributing the promotional message.

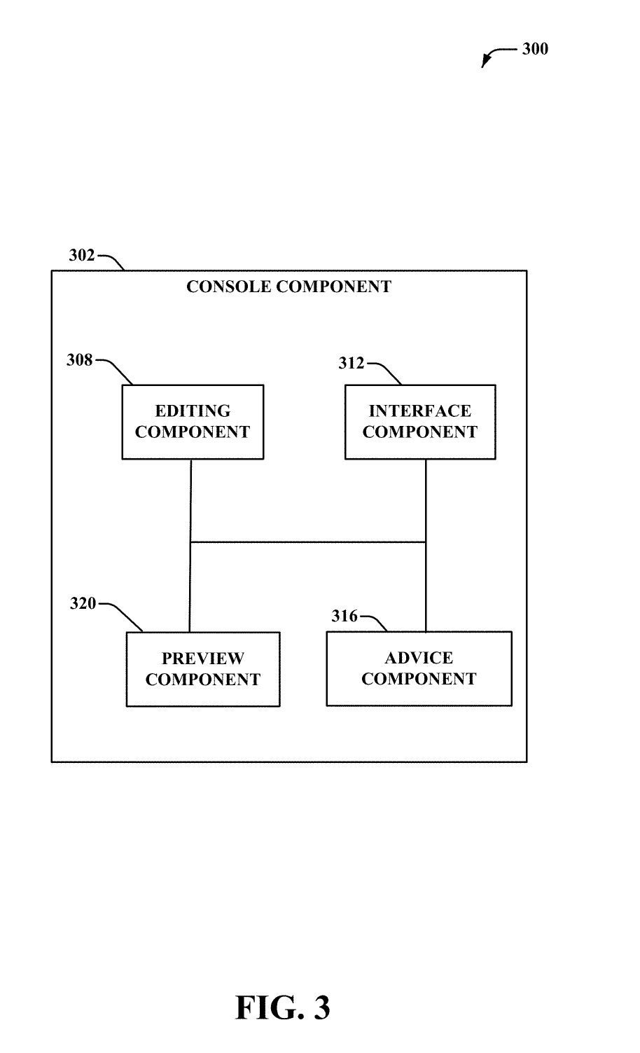

Referring now to FIG. 3, system 300 is depicted. System 300 can provide for assisting in generating a messaging campaign. System 300 can include all or a portion of system 100 as well as other systems or components detailed herein. In another aspect, system 300 can communicate with various components of system 100 and systems described below.

System 300 can include a console component 302 that facilitates creation of messaging campaigns. Console component 302 can optionally include editing component 308 for editing contents and settings of a messaging campaign; interface component 312 interacting with content creators; advice component 316 that provides suggestions and advice to content creators; and preview component 320 that generates a preview of a messaging campaign. It is noted that the various components can be comprised of one or more components and/or can perform one or more actions. While an action may be described as being performed by a particular component, it is noted that a disparate component can be employed to perform the action.

Console component 302 can receive input associated with one or more messaging campaigns. Input can include data representing a content creator's choice of settings; a message created by a content creator, and/or predetermined settings. In an embodiment, console component 302 receives settings associated with a messaging campaign and/or content of a messaging campaign. In another aspect, console component 302 can receive statistical data associated with a messaging campaign, such as data representing a performance metric (e.g., click rate of a message, open rate of a message, total clicks, total opens, forwarding rate of messages, etc.).

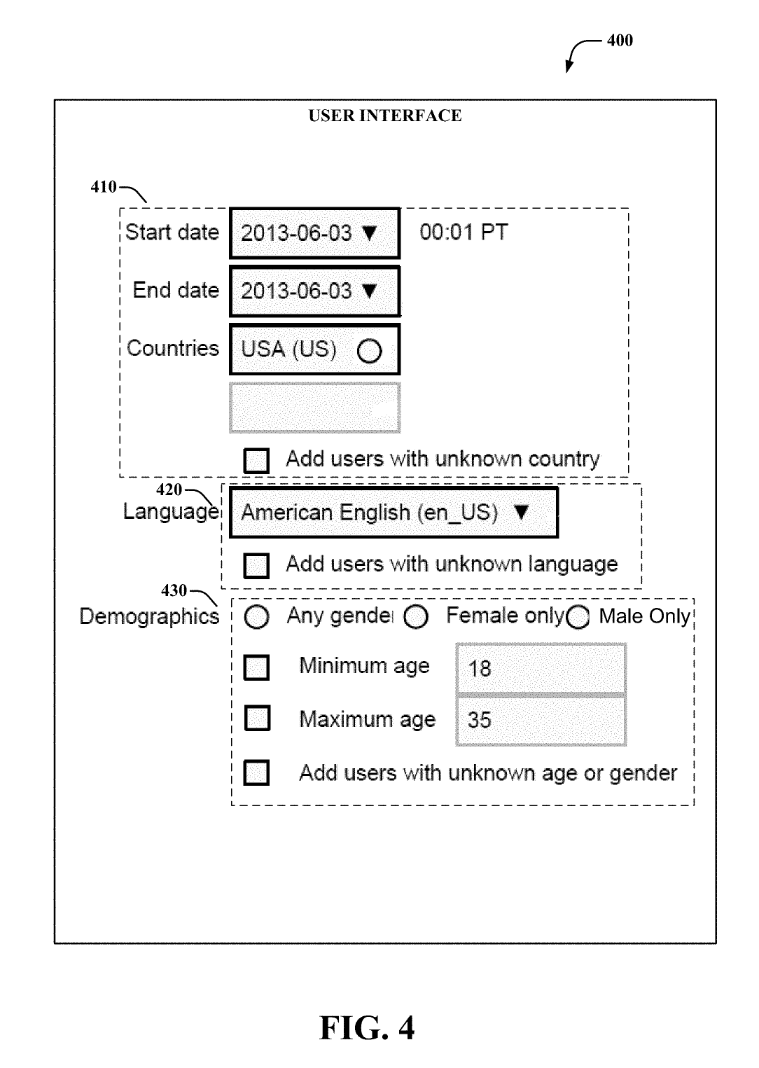

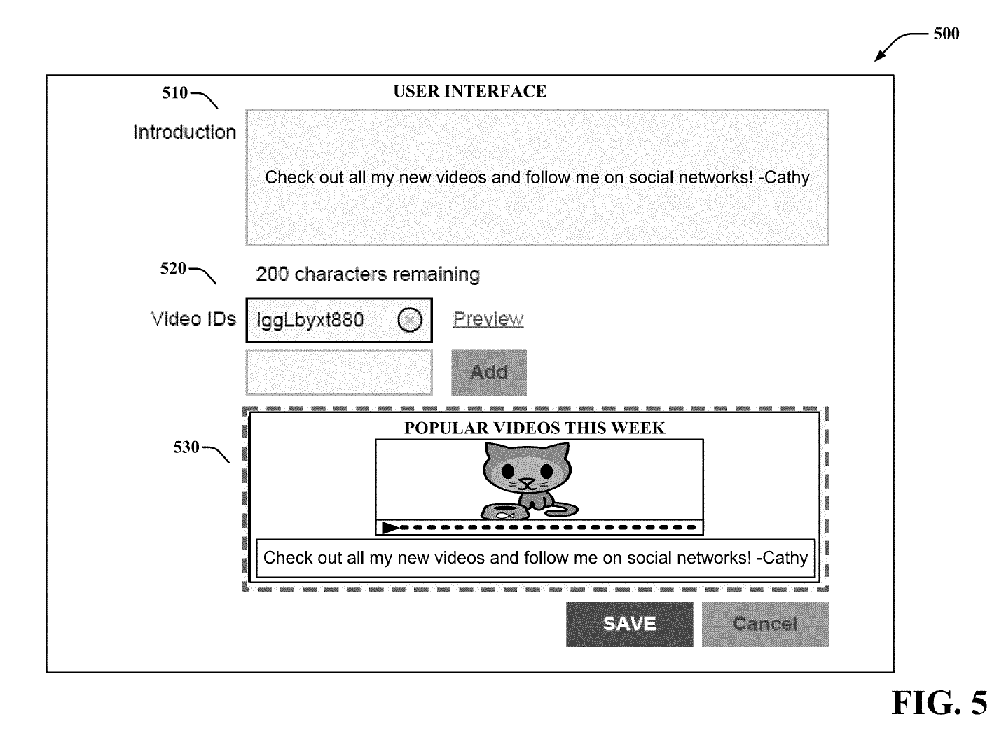

Referring now to FIGS. 4 and 5, with reference to FIG. 3, illustrated are user interface 400 and a user interface 500, respectively, that are exemplary displays facilitated by interface component 312. In an aspect, interface component 312 displays or facilitates display of user interface 400 and user interface 500 on a device, having a display that can be associated with a content creator.

In an embodiment, interface component 312 prompts a content creator to select criteria such as time period and location 410 (which describes desired start and end times of a campaign and desired locations of recipients to send the campaign); language 420 (which describes desired languages of targeted recipients); and demographics 430 (that describe desired demographics for targeting recipients). Interface component 312 can employ various techniques for gathering the criteria (e.g., check boxes, drop down boxes, radio buttons, text blocks).

In another aspect, interface component 312 can include user interface components. In an example, user interface components can comprise a display, input devices (e.g., a touch screen, a keyboard). Interface component 312 can be included in a device that can be associated with the content creator, for example. However, it is noted that, in embodiments, interface component 312 can reside outside of a device associated with a content creator, and can provide instructions to the device to facilitate user interface components to display content and/or receive input from a content creator.

Editing component 308 can receive data related to user input. In an aspect, the data can be stored in a memory, such as previously saved user input, or can be input in user interface 400 or user interface 500. As an example, editing component 308 can receive input from a content creator interacting with interface component 312. The input can comprise content for a messaging campaign and/or settings of a messaging campaign, as described with reference to FIG. 1. In an aspect, input can relate to altering a setting and/or content of a messaging campaign. For example, editing component 308 can populate fields in user interface 400 with previously stored settings associated with a content creator. The content creator, interacting with user interface 400, can alter, for example, demographics 430 to select a minimum age of 21.

Preview component 320 can present a preview of a message campaign integrated with a promotional campaign. In an embodiment, preview component 320 can generate a preview as an integrated message, without sending the integrated message. With reference to FIG. 5, a content creator can input text into a text area 510 and input a video idea representing a video to include in an integrated message, into a video area 520. Optionally, the content creator can select to preview their message or a preview can be automatically generated. The preview can be displayed in a preview area 530 of user interface 500. In an aspect, preview component 320 can instruct interface component 312 to display the preview. It is noted that preview component 320 can display a preview on a number of devices, such as a device associated with a content creator. It is further noted that preview component 320 can present all or a portion of an integrated message. For example, preview component 320 can display a message created by a content creator accessing the preview, digest content associated with a promotional campaign, and/or dummy values representing content not yet integrated into a message. Dummy values can comprise placeholders for future content.

Advice component 316 can provide data representing recommendations on contents of a messaging campaign. Advice component 316 can determine recommendations based on predefined templates, dynamically created templates, and the like. In embodiments, advice component 316 determines a recommendation according to statistical data associated with prior messaging campaigns. As an example, advice component 316 can analyze data representing a history associated with messaging campaigns (e.g., performance metrics of messaging campaigns, compositions of the messaging campaigns, settings of the messaging campaigns, etc.). In an aspect, advice component 316 can determine recognizable correlations between compositions of messaging campaigns, settings of messaging campaigns, and performance metrics. Advice component 316 can store recommendations for later use and/or instruct interface component 312 to present recommendations to a content creator. In another aspect, advice component 312 can monitor a content creator's acceptance or non-acceptance of a suggestion. Advice component 312 can learn a content creator's actions and make alternate suggestions and/or no suggestions based on the learned actions.

In an example, advice component 316 can determine performance level associated with the text, “Check out all my new videos and follow me on social networks!—Cathy”, entered in text area 510. Advice component 316 can, for example, determine that the text is not likely to result in a high performance level and can suggest text more likely to achieve high performance.

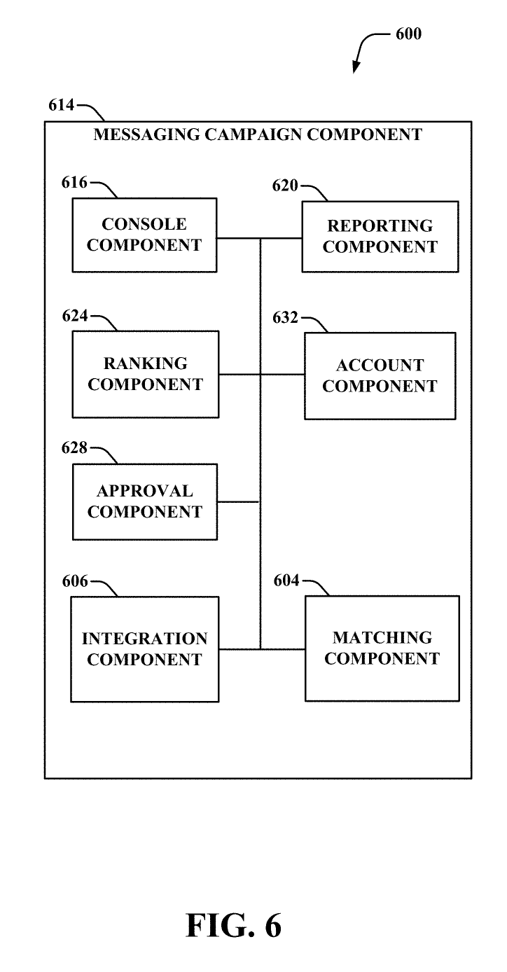

With reference to FIG. 6, depicted is system 600 that can facilitate generating a messaging campaign integrated with a promotional campaign, including aiding in creation of a messaging campaign. System 600 can include messaging campaign component 614 that comprises all or a portion of messaging campaign component 114. Messaging campaign component 614 can optionally include matching component 604 (that matches campaigns for integration); integration component 606 (that integrates matched campaigns and generates integrated messages); console component 616 (that facilitates creation of a messaging campaign); reporting component 620 (that generates statistical information associated with campaigns); ranking component 624 (that ranks campaigns based on one or more metrics); approval component 628 (that provides an approval flow for regulating messages); and account component 632 (that manages accounts associated with content creators). While depicted as separate components it is appreciated that, console component 616 can comprise all or part of console component 102, and/or console component 302; matching component 604 can perform actions similar to matching component 104; and integration component 606 can perform actions similar to integration component 106.

Reporting component 620 can report performance metrics to various components and/or content creators, through an interface. In an aspect, reporting component 620 can determine appropriate performance metrics (e.g., number of messages sent, number of messages opened, number of messages clicked, a number of messages shared and/or redistributed, and the like). In embodiments, reporting component 620 can compare performance metrics of a plurality of messaging campaigns and report on relative performances based on the comparison. It is noted that reporting component 620 can generate messages detailing performance metrics and send the generated messages to associated content creators.

In embodiments, reporting component 620 can provide content creators and various system components with reports of performance metrics. With reference to FIG. 3, advice component 316 can generate advice and/or suggestions based on performance metrics and/or associate messaging campaigns. As an example, a content creator can create a message campaign for integration facilitated by system 614. As an integrated campaign is sent to various end users, reporting component 620 can monitor when the content creator's message is clicked or otherwise accessed, and report the clicks to the content creator thereby providing the content creator with beneficial information relating to success of the messaging campaign.

Account component 632 can manage accounts associated with users, such as content creators. In embodiments, account component 632 can manage access to accounts through security protocols (e.g., password protection and the like). In another aspect, account component can manage monetary accounts associated with users. Account component 632, can determine credit and/or debit amounts based on statistical data, such as performance metrics reported by reporting component 620 (e.g., number of messages sent, messages opened, etc.). In an example, account component632 manages a payment account associated with a content creator and the content creator pays for integration of a messaging campaign, each message sent, priority placement of the content creator's message in a digest email, or other desired features.

In an aspect, account component 632 can be configured for prepaid models, post paid models, and/or the like. In a postpaid model, a user associated with a monetary account is billed after messages are sent and/or the account component 632 determines a credit/debit amount. In a prepaid model, account component 632 can check balance of a monetary account. Account component 632 can disable and/or enable aspects of system 600 based on a checked balance. For example, if account component 632 determines a balance is negative and/or zero, account manager can disable integration, creation, and/or sending of a messaging campaign. It is noted that various accounting techniques can be utilized, for example, a balance check can be in real-time, near real-time, and/or periodically. In an example, a content creator agrees to pay for each message sent to through the integrated campaign and provides an initial payment for 500 messages. As messages are sent to end users, account component 632 subtracts an appropriate amount from the content creator's account. When the content creator's account balance equals zero, the account component 632 can instruct the integration component 606 to remove the content creator's message from further campaigns, and/or prompt the content creator for an additional payment.

In embodiments, ranking component 624 can rank a messaging campaign based on one or more performance metrics. In an aspect, ranking component 624 can rank a messaging campaign based on comparing the messaging campaign to past campaigns and past performance metrics. In an embodiment, the ranking component 624 can generate a sample set of users meeting criteria of campaigns. The users can represent a subset of total users that would be sent an integrated campaign. The sample set can be sent the integrated campaign before all users receive the integrated campaign. The ranking component can determine rank based on performance metrics associated with the sample set of users. In an aspect, a content creator can utilize console component 616 to edit a messaging campaign if a ranking falls below a desired performance threshold. In another aspect, the ranking component 624 can automatically notify a content creator when a ranking falls below a threshold and a suggested change can be presented to a user, for example. For example, ranking component 624 can monitor performance of a content creator's message through click rates and the like. The performance can be sent to the content creator who can determine if the message is performing as well as they would have liked. If the content creator is unhappy with the ranking, the content creator can edit the message to improve performance.

Approval component 628 can determine whether or not to approve a messaging campaign. In embodiments, approval component 628 can automatically determine whether or not to approve a messaging campaign based on analysis of content and/or settings of the messaging campaign. For example, approval component 628 can apply a policy to contents of a messaging campaign. A policy can determine whether or not to approve a messaging campaign based on, for example, words determined to be inappropriate (e.g., misspelled words, vulgar words, etc.), formatting correctness, human interpretation, media determined to be inappropriate, and the like. In an aspect, a policy can be predetermined and/or dynamically determined. For example, approval component 628 can determine a policy based on targeting signals (e.g., such as targeting signals input to console component 616) associated with a messaging campaign and/or promotional campaign. As another example, approval component 628 can determine whether or not a word is an undesirable word based on demographic(s) of a target audience associated with a campaign (e.g., different words for different age groups). It is noted that approval component 628 can receive input from users to determine whether or not to approve a messaging campaign and/or analyze content based on image recognition, audio recognition, text recognition, and the like.

In embodiments, approval component 628 can notify a content creator when it determines whether or not to approve a messaging campaign. In an aspect, integration component 606 can integrate an approved messaging campaign and a promotional campaign, automatically and/or after content creator acceptance of approval. In another aspect, in response to determining a messaging campaign is not approved, integration component 606 can notify a content creator and indicate reason for not approving (e.g., rejecting) the messaging campaign.

Approval component 628 can receive input from a content creator indicating the content creator desires to appeal the rejection of the messaging campaign. For example, a content creator can select an appeal option, e.g., in an interface, and can provide optional comments. In response to receiving input representing an appeal, approval component 628 can apply a policy to re-analyze the messaging campaign and/or elevate determining whether or not to approve a messaging campaign to another resource, such as a human interacting with approval component 628. It is noted that re-analyzing can utilize a disparate policy than the policy first used. For example, approval component 628 can determine to utilize a policy based on comments received from the content creator, (e.g., utilizing a different image recognition technique based on appeal comments indicating that the content creator believes an image in the messaging campaign should be approved).

In various embodiments, approval component 628 can automatically correct a messaging campaign and/or generate suggested corrections. Suggested corrections can be approved by a content creator, e.g., through console component 616. If approval component 628 corrects, automatically or based on content creator acceptance, a messaging campaign, then integration component 606 can integrate the messaging campaign with one or more promotional campaigns.

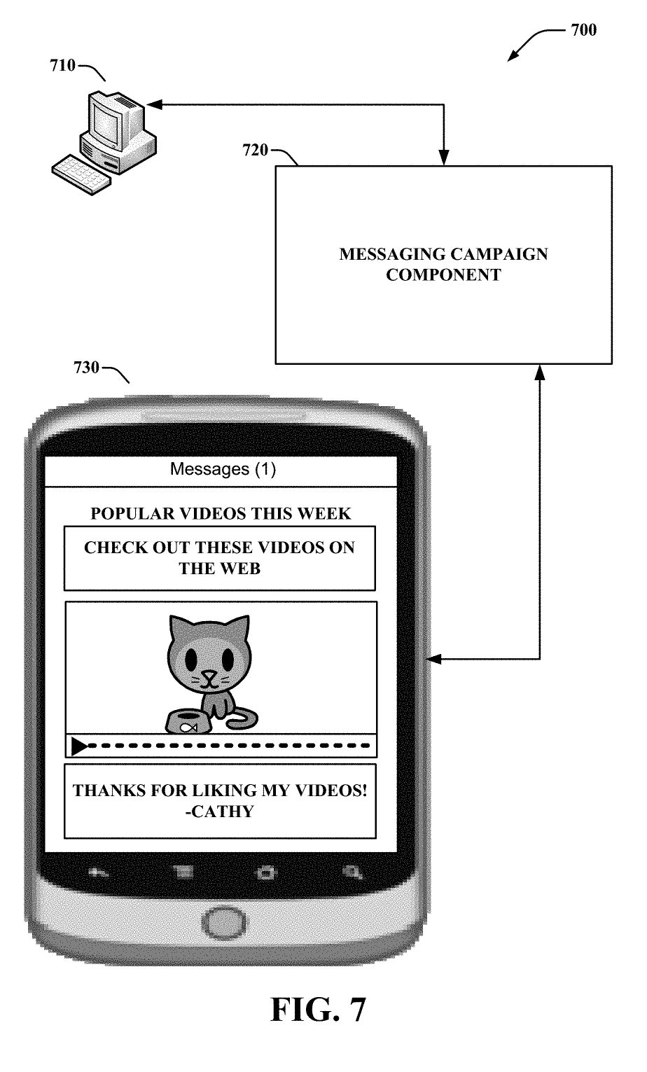

With reference to FIG. 7, a system 700, which integrates campaigns, is depicted. System 700 provides a high-level functional diagram of content creator device 710 interacting with messaging campaign component 720 to deliver a personalized message to user device 730 (which is associated with a user). It is note that content creator device 710 and user device 730 can consist of various devices (e.g., computers, smart phones, tablets, cameras, PDA's). It is further noted that messaging campaign component 720 can comprise various embodiments described herein.

As illustrated, a content creator can interact with content creator device 710 to select settings, input content, and the like. For example, content creator device 710 can display user interface screens, such as user interface 400 and user interface 500. It is noted that messaging campaign component 720 can instruct content creator device 710 to display various interface screens.

Messaging campaign component 720 can receive data from content creator device 710 and perform operations, such as matching, integrating, and the like, in accordance with various embodiments herein. In an aspect, messaging campaign component 720 identifies a user associated with user device 730 is an appropriate user to receive an integrated message associated with the content creator. In response, the messaging campaign component 720 can send the integrated message to user device 730.

User device 730 can allow a user to access email, text messaging, and the like. The user can select the integrated message and user device 730 can present the message to the user. The message can comprise personalized content associated with a content creator. The personalized content removes the automated feel of messages and increases the likelihood that a user will view the content.

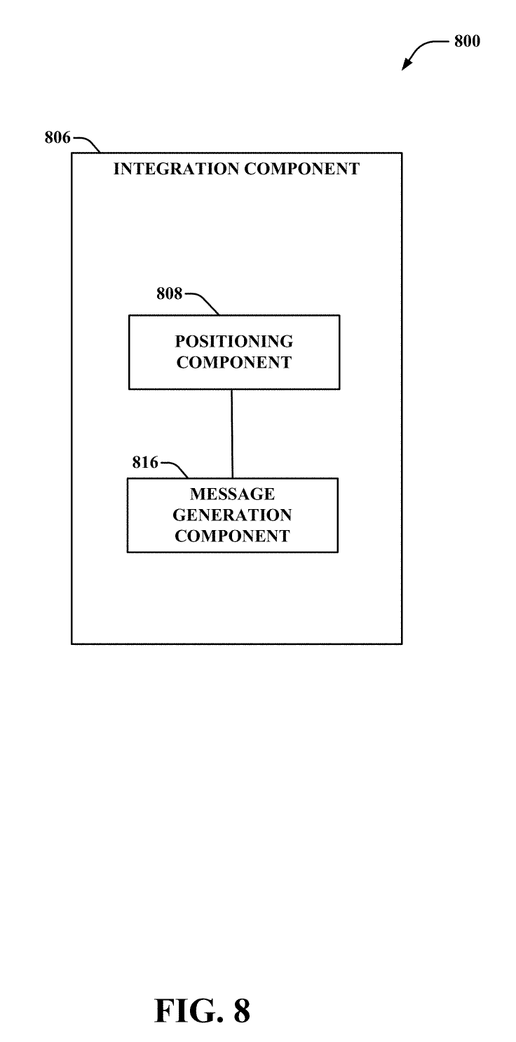

Turning to FIG. 8, system 800 is depicted that provides an integration component 805 that can integrate one or more campaigns. Integration component 806 can comprise capabilities similar to integration component 606 and integration component 106. Optionally, integration component 806 can include positioning component 808 (which determines a position of a user created message in a digest message) and message generation component 816 (which generates messages and sends messages to targeted users).

In embodiments, integration component 806 can integrate messaging campaigns and promotional campaigns to generate integrated messaging campaigns. It is noted that integration component 806 can integrate campaigns of various formats—integration component 806 can integrate two or more campaigns. For example, with reference to FIG. 1, matching component 104 can identify a plurality of messaging campaigns to be integrated with a promotional campaign. Positioning component 808 can determine positions of content of each messaging campaign in a digest message associated with an integrated campaign. For example, positioning component 808 can determine to position a content creator's message at a position in a display that is near a position of digest content related to the content creator.

In embodiments, positioning component 808 can determine whether or not to include a content creator's messaging campaign and where in a message to include a content creator's message based on statistical data, payment data, and the like. In an aspect, statistical data can comprise data identifying a target user's history, data identifying performance metrics of past campaigns and associated content creators, affinity levels of content creators and target users, and the like. In an aspect, affinity levels can be represented by token values determined based on user history, and the like. It is noted that an affinity level can be a number value, a specified level (e.g., high, medium, low, etc.), relative affinities, and/or the like. For exampled, positioning component 808 can determine to position content, associated with a first content creator that a user has a strongest affinity to, near top of an email, while content, associated with a second content creator that a user has a lower affinity to, can be positioned below.

Payment data can include a balance of a content creator, a type of content creator, and the like. In an aspect, a type of content creator can be a paying content creator, a non-paying content creator, an advertiser, and the like. It is noted that payment data can include a payment amount. For example, a content creator can pay a relatively higher amount to obtain a desired position.

In another example, multiple messaging campaigns can be selected for integration. Positioning component 808 can determine where to position each campaign and/or a number of campaigns to integrate. Continuing with the example, positioning component 808 can determine to position content based on a target user's most recently accessed content. Most recently accessed content can include content created by a first content creator who is also associated with a messaging campaign.

Message generation component 816 can generate an integrated message based on identified campaigns and/or output of positioning component 808. In an aspect, messaging component 816 can generate messages of various formats. Message generation component 816 generates messages based on data associating a user with a particular format. For example, message generation component 816 can generate email messages for a user associated with an email address, a cellular message for a user associate with a phone number, a print message for users associated with a physical address, and the like. In another example, data associating a user with a particular format can include device types associate with a user, user preference and the like. For example, message generation component 816 can generate a HTML messages for users preferring HTML messages.

Message generation component 816 can generate an integrated message by forming a message and/or outputting the message. Outputting can comprise uploading, publishing, and/or otherwise communicating the message.

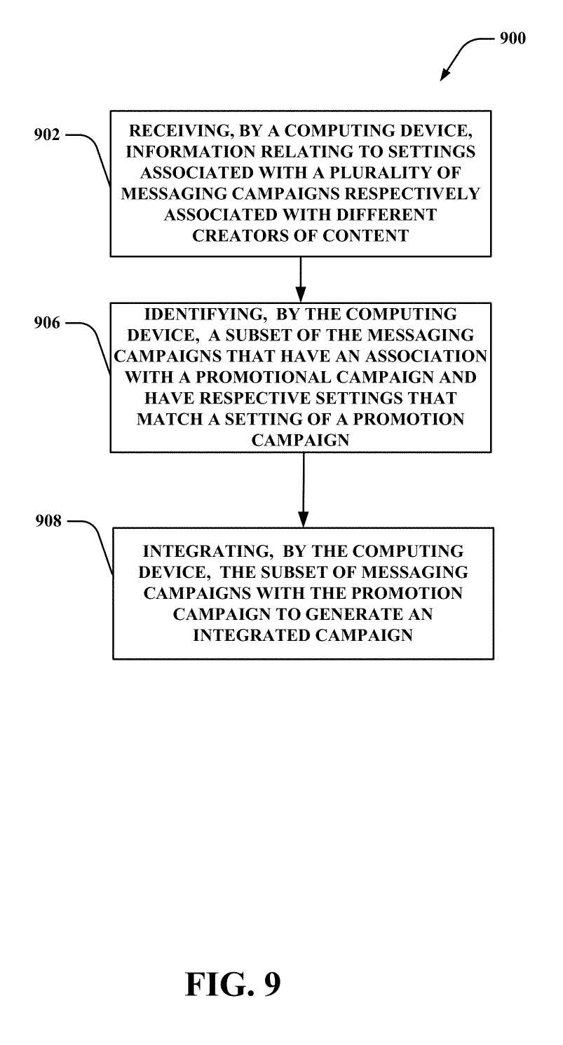

FIGS. 9-13 illustrate various methodologies in accordance with certain embodiments of this disclosure. While, for purposes of simplicity of explanation, the methodologies are shown and described as a series of acts within the context of various flowcharts, it is to be understood and appreciated that embodiments of the disclosure are not limited by the order of acts, as some acts may occur in different orders and/or concurrently with other acts from that shown and described herein. It is noted that a methodology can alternatively be represented as a series of interrelated states or events, such as in a state diagram. Moreover, not all illustrated acts may be required to implement a methodology in accordance with the disclosed subject matter. Additionally, it is to be further noted that the methodologies disclosed hereinafter and throughout this disclosure are capable of being stored on an article of manufacture to facilitate transporting and transferring such methodologies to computers. The term article of manufacture, as used herein, is intended to encompass a computer program accessible from any computer-readable device or storage media.

With reference to FIG. 9, there is illustrated a methodology 900 for integrating one or more campaigns, according to an aspect of this disclosure. As an example, various media applications, such as, but not limited to, messaging campaign systems, social networking systems, and user generated content systems can use methodology 900. Specifically, methodology 900 integrates multiple campaigns into an integrated campaign.

At 902, information relating to settings associated with a plurality of messaging campaigns respectively associated with different creators of content is received by a computing device (e.g., messaging campaign component 114, 614, etc.). In an aspect, a creator of content can be associated with one or more messaging campaigns. In another aspect, information relating to settings can include targeting signals for selecting an audience, data describing a time period (e.g., start and end time) for campaigns, and the like.

At 906, a subset of the messaging campaigns that have an association with a promotional campaign and have respective settings that match a setting of a promotion campaign are identified by the computing device (etc., matching component 104, 604, etc.). It is noted that matching can describe an identical match and/or similar match. For example, if time periods overlap, a system can determine that settings match.

At 908, the subset of messaging campaigns can be integrated, by the computing device (e.g., integration component 106, 606, 806, etc.), with the promotion campaign to generate an integrated campaign. In embodiments, integrating can including adding content of messaging campaigns to a promotion campaign, in accordance with various embodiments disclosed herein.

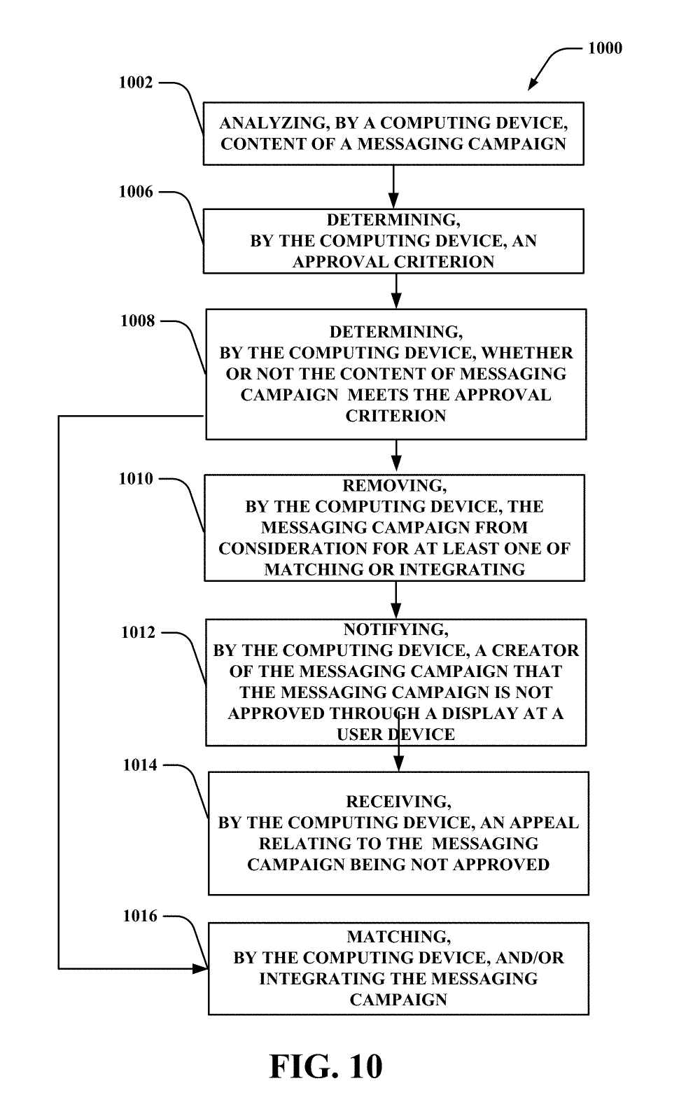

With reference to FIG. 10, there is illustrated a methodology 1000 for integrating one or more campaigns including an approval flow, according to an aspect of this disclosure. As an example, various media applications, such as, but not limited to, messaging campaign systems, social networking systems, and user generated content systems can use methodology 1000. Specifically, methodology 1000 determines whether or not to approve a messaging campaign and an appeal flow.

At 1002, content of a messaging campaign can be analyzed by a computing device (e.g., messaging campaign component 114, 614, etc.). In embodiments, analyzing content can include analyzing content based on image recognition, audio recognition, text recognition, and the like.

At 1006, an approval criterion can be determined by the computing device (e.g., approval component 628). In embodiments, an approval criterion can be a policy. A policy can determine whether or not to approve a messaging campaign based on, for example, words determined to be inappropriate (e.g., misspelled words, vulgar words, etc.), formatting correctness, human interpretation, media determined to be inappropriate, and the like. In an aspect, a policy can be predetermined and/or dynamically determined. For example, a policy can be based on targeting signals (e.g., such as targeting signals input to console component 616) associated with a messaging campaign and/or promotional campaign. As another example, an approval criterion can indicate whether or not a word is a bad word based on a demographic of a target audience associated with a campaign.

At 1008 the computing device (e.g., approval component 628) can determine whether or not content of the messaging campaign meets approval criterion. Determining whether or not content of the messaging campaign meets the approval criterion can be based on the analysis of the messaging campaign and the determined approval criterion. If it is determined that the content is approved, method 1000 can continue to 1016. If it is determined that the content is not approved, method 1000 can continue to 1010.

At 1010, a messaging campaign, that is determined not to be approved, can be removed, by the computing device (e.g., approval component 628), from consideration for at least one of matching or integrating. For example, a rejected or not approved message can be determined to be a bad and/or inappropriate message. Therefore, the message should not be distributed and need not be considered for matching and/or integration.

At 1012, a creator of the messaging campaign can be notified, by a computing device (e.g., approval component 628) through an interface (e.g., interface component 312), that the messaging campaign is not approved. Notifying can include generation and sending of an email, causing an interface to display a message, and the like. In an aspect, notifying can include notifying a reason for not approving the messaging campaign (e.g., inappropriate settings, bad words, bad formatting, etc.).

At 1014, the computing device (e.g., approval component 628) can receive an appeal relating to the messaging campaign being not approved. 1014 can include receiving input from a content creator indicating the content creator desires to appeal the rejection of the messaging campaign. For example, a content creator can select an appeal option, e.g., in an interface, and can provide optional comments. In response to receiving input representing an appeal, method 1000 can apply a policy to re-analyze the messaging campaign and/or elevate determining whether or not to approve a messaging campaign to another resource, such as a human interacting with a device.

At 1016, the messaging campaign can be matched and/or integrated by the computing device (e.g., messaging campaign component 114, 614, etc.). Integration of an approved messaging campaign and a promotional campaign can be automatically and/or after content creator acceptance or final approval.

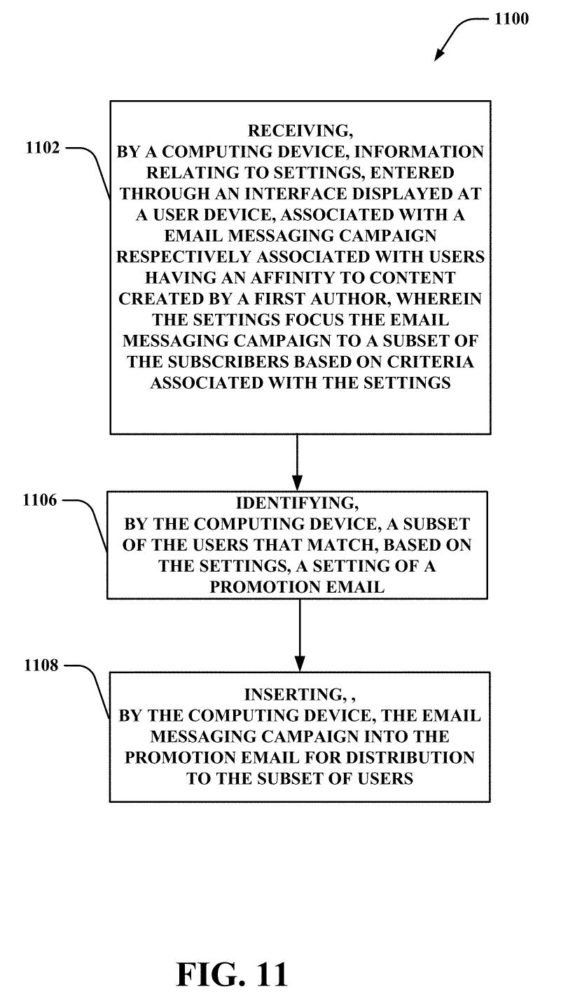

With reference to FIG. 11, there is illustrated a methodology 1100 for integrating one or more campaigns including integrating emails, according to an aspect of this disclosure. As an example, various media applications, such as, but not limited to, messaging campaign systems, social networking systems, and user generated content systems can use methodology 1100. Specifically, methodology 1100 inserts matched email messaging campaigns into promotional emails.

At 1102, a computing device, (e.g., messaging campaign component 114, 614, etc.), can receive information relating to settings associated with an email messaging campaign respectively associated with users having an affinity to content created by a first author, wherein the settings focus the email messaging campaign to a subset of the subscribers based on criteria associated with the settings. For example, a content creator can input settings for a messaging campaign. In another aspect, default settings can be received from memory, for example. In another aspect, an affinity can be determined based on any number of appropriate factors, as described herein.

At 1106, a subset of the users that match, based on the settings, a setting of a promotion email are identified by the computing device (e.g., matching component 104, 604, etc.). In an aspect, a system can access a database for example and determine a number of users that meet criteria of a messaging campaign (e.g., age, language, etc.).

At 1108, the computing device, (e.g., integration component 106, 606, 806, etc.), can insert the email messaging campaign into the promotion email for distribution to the subset of subscribers. For example, a message can be inserted to a promotion email as depicted in FIG. 2. It is noted that inserting the email messaging campaign can include determining an appropriate position in a promotional email, formatting the email messaging campaign, and the like.

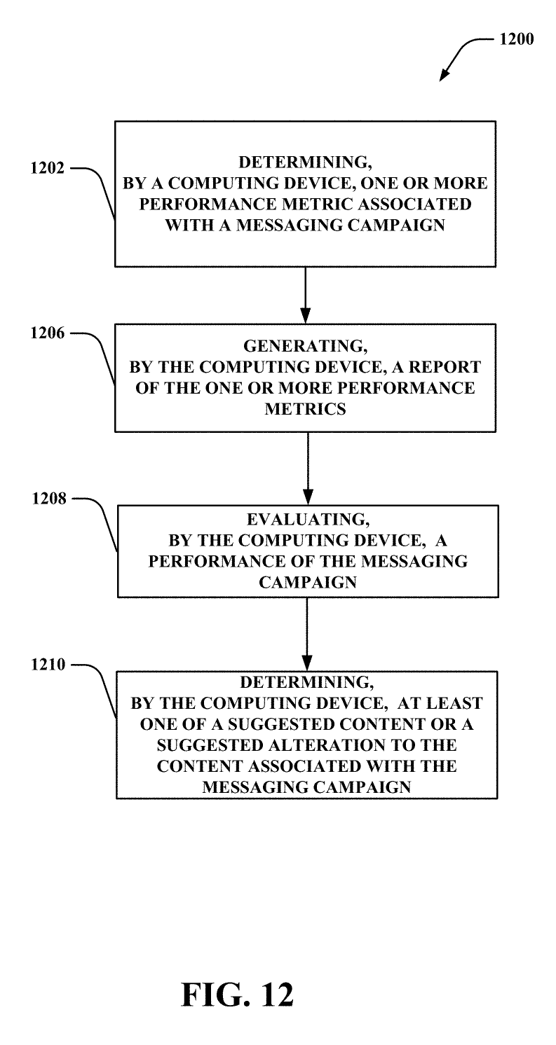

With reference to FIG. 12, there is illustrated a methodology 1200 for integrating one or more campaigns including determining performance metrics, according to an aspect of this disclosure. As an example, various media applications, such as, but not limited to, messaging campaign systems, social networking systems, and user generated content systems can use methodology 1200. Specifically, methodology 1200 can determine performance metrics associated with a messaging campaign.

At 1202, a computing device, (e.g., reporting component 620, etc.), can determine one or more performance metric associated with a messaging campaign. Appropriate performance metrics such as a number of messages sent, a number of messages opened, a number of messages click, a number of messages shared and/or redistributed, and the like can be determined. In embodiments, performance metrics of a plurality of messaging campaigns can be compared to generate performance metrics.

At 1206, the computing device (e.g., reporting component 620, etc.), can generate a report of the one or more performance metrics. In embodiments, generating a report can include providing content creators with a report of performance metrics.

At 1208, the computing device, (e.g., ranking component 624, etc.), can evaluate a performance of the messaging campaign. For example, a system can evaluate a history of performance to compare performance metrics associated with the messaging campaign.

At 1210, the computing device, (e.g., advice component 316, etc), can determine at least one of a suggested content or a suggested alteration to the content associated with the messaging campaign. For example, a system can determine identifiable patterns associated with a relatively higher performance metric than a performance metric associated with the messaging campaign. The system can generate advice and/or suggestions based on the comparison.

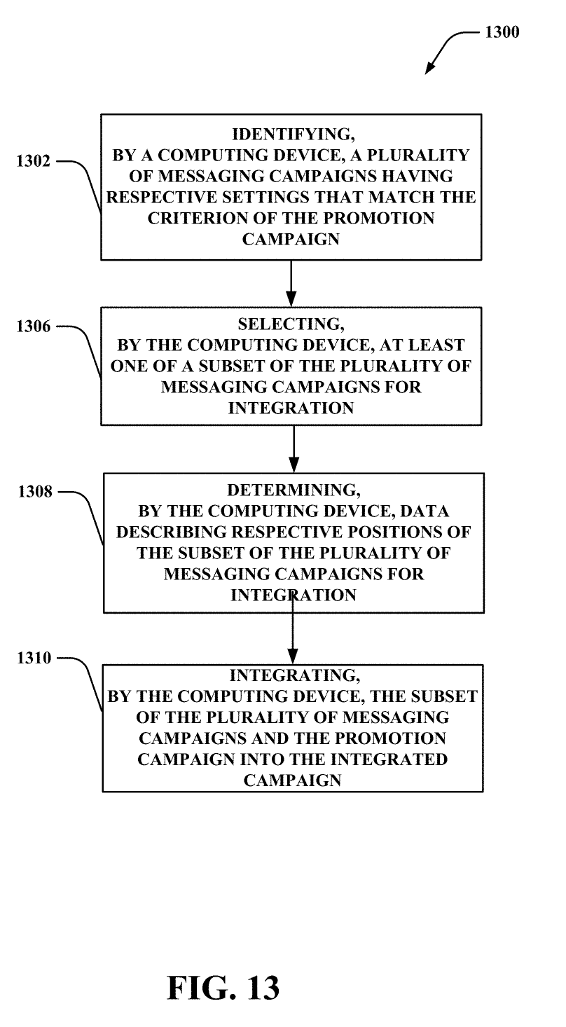

With reference to FIG. 13, there is illustrated a methodology 1300 for integrating one or more campaigns from a plurality of messaging campaigns, according to an aspect of this disclosure. As an example, various media applications, such as, but not limited to, messaging campaign systems, social networking systems, and user generated content systems can use methodology 1300. Specifically, methodology 1300 integrates a subset of messaging campaigns at determined positions. At 1302, a system can identify a plurality of messaging campaigns having respective setting that match the criterion of the promotion campaign, as described herein.

At 1306, at least one of a subset of the plurality of messaging campaigns can be selected for integration by a computing device (e.g., etc., matching component 104, 604, etc.), for example, based on the identification. In another aspect, a system can select at least one of a subset of the plurality of messaging campaigns for integration based on an association with a target user, a setting of a content creator associated with a messaging campaign (e.g., paying content creator), and the like.

At 1308, the computing device (e.g., positioning component 808) can determine data describing respective positions of the subset of the plurality of messaging campaigns for integration. For example, as system can determine a content portion of a messaging campaign should be integrated in a message of a promotion campaign, and setting of the messaging campaign should be integrated with settings of the promotion campaign.

At 1310, the computing device (e.g., message generation component 816, integration component 106, 806, etc.) can integrate the subset of the plurality of messaging campaigns and the promotion campaign into the integrated campaign, as described herein.

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

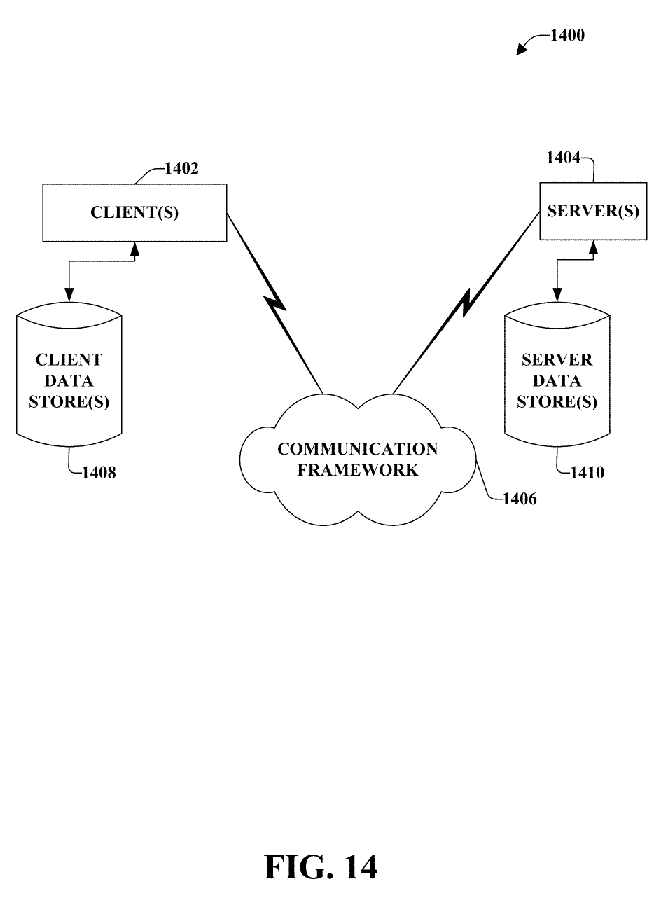

Referring now to FIG. 14, there is illustrated a schematic block diagram of a computing environment 1400 in accordance with this specification. The system 1400 includes one or more client(s) 1402, (e.g., computers, smart phones, tablets, cameras, PDA's). The client(s) 1402 can be hardware and/or software (e.g., threads, processes, computing devices). The client(s) 1402 can house cookie(s) and/or associated contextual information by employing the specification, for example.

The system 1400 also includes one or more server(s) 1404. The server(s) 1404 can also be hardware or hardware in combination with software (e.g., threads, processes, computing devices). The servers 1404 can house threads to perform transformations by employing aspects of this disclosure, for example. One possible communication between a client 1402 and a server 1404 can be in the form of a data packet adapted to be transmitted between two or more computer processes wherein data packets may include coded campaigns and/or integrate campaigns. The data packet can include a cookie and/or associated contextual information, for example. The system 1400 includes a communication framework 1406 (e.g., a global communication network such as the Internet) that can be employed to facilitate communications between the client(s) 1402 and the server(s) 1404.

Communications can be facilitated via a wired (including optical fiber) and/or wireless technology. The client(s) 1402 are operatively connected to one or more client data store(s) 1408 that can be employed to store information local to the client(s) 1402 (e.g., cookie(s) and/or associated contextual information). Similarly, the server(s) 1404 are operatively connected to one or more server data store(s) 1410 that can be employed to store information local to the servers 1404.

In one implementation, a client 1402 can transfer an encoded file, (e.g., encoded campaigns), to server 1404. Server 1404 can store the file, decode the file, or transmit the file to another client 1402. It is to be appreciated, that a client 1402 can also transfer uncompressed file to a server 1404 and server 1404 can compress the file in accordance with the disclosed subject matter. Likewise, server 1404 can encode video information and transmit the information via communication framework 1406 to one or more clients 1402.

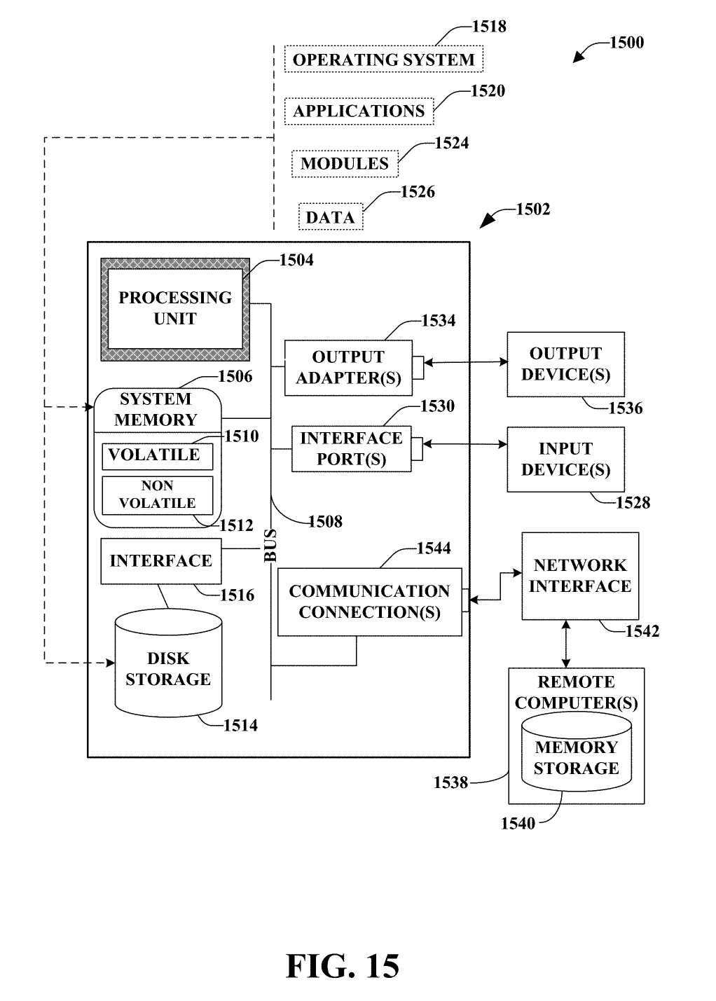

With reference to FIG. 15, a suitable environment 1500 for implementing various aspects of the claimed subject matter includes a computer 1502. The computer 1502 includes a processing unit 1504, a system memory 1506, a codec 1505, and a system bus 1508. The system bus 1508 couples system components including, but not limited to, the system memory 1506 to the processing unit 1504. The processing unit 1504 can be any of various available processors. Dual microprocessors and other multiprocessor architectures also can be employed as the processing unit 1504.

The system bus 1508 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1506 includes volatile memory 1510 and non-volatile memory 1512. The basic input/output system (BIOS), containing the basic routines to transfer information between elements within the computer 1502, such as during start-up, is stored in non-volatile memory 1512. By way of illustration, and not limitation, non-volatile memory 1512 can include read only memory (ROM), programmable ROM (PROM), electrically programmable ROM (EPROM), electrically erasable programmable ROM (EEPROM), or flash memory. Volatile memory 1510 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM).

Computer 1502 may also include removable/non-removable, volatile/non-volatile computer storage media. FIG. 15 illustrates, for example, a disk storage 1514. Disk storage 1514 includes, but is not limited to, devices like a magnetic disk drive, solid state disk (SSD) floppy disk drive, tape drive, Zip drive, LS-100 drive, flash memory card, or memory stick. In addition, disk storage 1514 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1514 to the system bus 1508, a removable or non-removable interface is typically used, such as interface 1516.

It is to be appreciated that FIG. 15 describes software, software in execution, hardware, and/or software in combination with hardware that acts as an intermediary between users and the basic computer resources described in the suitable operating environment 1500. Such software includes an operating system 1518. Operating system 1518, which can be stored on disk storage 1514, acts to control and allocate resources of the computer system 1502. Applications 1520 take advantage of the management of resources by operating system 1518 through program modules 1524, and program data 1526, such as the boot/shutdown transaction table and the like, stored either in system memory 1506 or on disk storage 1514. It is to be appreciated that the claimed subject matter can be implemented with various operating systems or combinations of operating systems. For example, applications 1520 and program data 1526 can include software implementing aspects of this disclosure.

A user enters commands or information into the computer 1502 through input device(s) 1528. Input devices 1528 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1504 through the system bus 1508 via interface port(s) 1530. Interface port(s) 1530 include, for example, a serial port, a parallel port, a game port, and a universal serial bus (USB). Output device(s) 1536 use some of the same type of ports as input device(s) 1528. Thus, for example, a USB port may be used to provide input to computer 1502, and to output information from computer 1502 to an output device 1536. Output adapter 1534 is provided to illustrate that there are some output devices 1536 like monitors, speakers, and printers, among other output devices 1536, which require special adapters. The output adapters 1534 include, by way of illustration and not limitation, video and sound cards that provide a means of connection between the output device 1536 and the system bus 1508. It should be noted that other devices and/or systems of devices provide both input and output capabilities such as remote computer(s) 1538.

Computer 1502 can operate in a networked environment using logical connections to one or more remote computers, such as remote computer(s) 1538. The remote computer(s) 1538 can be a personal computer, a server, a router, a network PC, a workstation, a microprocessor based appliance, a peer device, a smart phone, a tablet, or other network node, and typically includes many of the elements described relative to computer 1502. For purposes of brevity, only a memory storage device 1540 is illustrated with remote computer(s) 1538. Remote computer(s) 1538 is logically connected to computer 1502 through a network interface 1542 and then connected via communication connection(s) 1544. Network interface 1542 encompasses wire and/or wireless communication networks such as local-area networks (LAN), wide-area networks (WAN), and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1544 refers to the hardware/software employed to connect the network interface 1542 to the bus 1508. While communication connection 1544 is shown for illustrative clarity inside computer 1502, it can also be external to computer 1502. The hardware/software necessary for connection to the network interface 1542 includes, for exemplary purposes only, internal and external technologies such as, modems including regular telephone grade modems, cable modems and DSL modems, ISDN adapters, wired and wireless Ethernet cards, hubs, and routers.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described herein can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize. Moreover, use of the term “an embodiment” or “one embodiment” throughout is not intended to mean the same embodiment unless specifically described as such.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing integration functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable medium; or a combination thereof.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used herein differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

1. A system comprising:
a memory that has stored thereon computer executable instructions; and
a hardware processor, that when executing the computer executable instructions stored in the memory, is configured to:
receive information relating to settings associated with a plurality of messaging campaigns respectively associated with a plurality of different creators of content;
identify a subset of the plurality of messaging campaigns having respective settings that match a criterion of a promotion campaign;
identify a user to receive a message related to the promotion campaign based on an affinity of the user for content of the subset of the plurality of messaging campaigns, wherein the message related to the promotion campaign is inserted into at least one of the digest emails and wherein the affinity of the user for the content of the subset of the plurality of messaging campaigns is based on data indicating that the user has previously subscribed to a channel of content associated with a creator of the content of the subset of the plurality of messaging campaigns;
in response to determining that the subset of the plurality of messaging campaigns has respective settings that match the criterion of the promotion campaign, create the message that includes the subset of the plurality of messaging campaigns based on the promotion campaign;
modify the at least one digest email to incorporate the created message that includes the subset of the plurality of message campaigns based on the promotion campaign; and
transmit the at least one digest email that incorporates the created message to the user device associated with the user.

2. The system of claim 1, wherein the hardware processor is further configured to receive the settings regarding at least one of a time period of the plurality of messaging campaigns or an audience targeting signal.

3. The system of claim 1, wherein the hardware processor is further configured to identify whether or not the creator of content of a messaging campaign of the subset of the plurality of messaging campaigns is associated with a content of the promotion campaign and the messaging campaign is only included in the message in response to determining that the setting of the messaging campaign matches the criterion of the promotion campaign and that the creator of content is associated with the content of the promotion campaign.

4. The system of claim 1, wherein the hardware processor is further configured to determine one or more performance metrics associated with the message wherein the one or more performance metrics includes a number of times the message was opened.

5. (canceled)

6. The system of claim 1, wherein the hardware processor is further configured to:
determine a performance metric associated with a messaging campaign of the subset of the plurality of messaging campaigns based at least in part on a number of times the message was opened; and
provide at least one of a suggested content or a suggested alteration to the content associated with the messaging campaign of the subset of the plurality of messaging campaigns.

7. (canceled)

8. The system of claim 1, wherein the promotion campaign is an email campaign, and wherein the hardware processor is further configured to integrate a messaging campaign of the subset of the plurality of messaging campaigns into one or more emails associated with the promotion campaign.

9. (canceled)

10. The system of claim 1, wherein the hardware processor is further configured to determine data describing respective positions of the subset of the plurality of messaging campaigns, wherein the subset of the plurality of messaging campaigns are included in the message based on the respective positions.

11. (canceled)

12. The system of claim 1, wherein the hardware processor is further configured to receive indications for placement of content associated with the creator of content from the creator of content in association with an account associated with the creator of content.

13. A method comprising:
using a processor to execute computer executable components stored on a computer readable medium to perform the following acts:
receiving information relating to settings associated with a plurality of messaging campaigns respectively associated with a plurality of different creators of content;
identifying a subset of the plurality of messaging campaigns that have an association with a promotional campaign and have respective settings that match a criterion of a promotion campaign;
identifying a user to receive a message related to the promotion campaign based on an affinity of the user for content of the subset of the plurality of messaging campaigns, wherein the message related to the promotion campaign is inserted into at least one of the digest emails and wherein the affinity of the user for the content of the subset of the plurality of messaging campaigns is based on data indicating that the user has previously subscribed to a channel of content associated with a creator of the content of the subset of the plurality of messaging campaigns;
in response to determining that the subset of the plurality of message campaigns has respective settings that match the criterion of the promotion campaign, creating the message that includes the subset of messaging campaigns based on the promotion campaign;
modifying the at least one digest email to incorporate the created message that includes the subset of the plurality of message campaigns based on the promotion campaign; and
transmitting the at least one digest email that incorporates the created message to the user device associated with the user.

14. The method of claim 13, wherein the method further comprises determining whether or not a messaging campaign of the plurality of messaging campaigns meets an approval criterion related to language included in the messaging campaign.

15. The method of claim 14, wherein the method further comprises determining that the messaging campaign of the plurality of messaging campaigns is to be removed from the plurality of messaging campaigns based on the language included in the messaging campaign and based on the target audience of the messaging campaign.

16. The method of claim 15, wherein the method further comprises:
receiving, from the creator of the content, data indicating an appeal of determining that the messaging campaign of the plurality of messaging campaigns does not meet the approval criterion; and
causing the messaging campaign to be analyzed using a different technique than a technique used to determine that the messaging campaign does not meet the approval criterion.

17. A non-transitory computer readable storage medium comprising computer executable instructions that, in response to execution, cause a computing system comprising a processor to perform operations, comprising:
receiving information relating to settings associated with a plurality of messaging campaigns respectively associated with a plurality of different creators of content;
identifying a subset of the plurality of messaging campaigns having respective settings that match a criterion of a promotion campaign;
identifying a user to receive a message related to the promotion campaign based on an affinity of the user for content of the subset of the plurality of messaging campaigns, wherein the message related to the promotion campaign is inserted into at least one of the digest emails and wherein the affinity of the user for the content of the subset of the plurality of messaging campaigns is based on data indicating that the user has previously subscribed to a channel of content associated with a creator of the content of the subset of the plurality of messaging campaigns;
in response to determining that the subset of the plurality of messaging campaigns has respective settings that match the criterion of the promotion campaign, creating the message that includes the subset of the plurality of messaging campaigns based on the promotion campaign;
modifying the at least one digest email to incorporate the created message that includes the subset of the plurality of message campaigns based on the promotion campaign; and
transmitting the at least one digest email that incorporates the created message to the user device associated with the user.

18. (canceled)

19. The non-transitory computer readable storage medium of claim 17, wherein identifying the user based on affinity of the user to the content is based on at least one of explicit behavior associated with the user or implicit behavior associated with the user.

20. The non-transitory computer readable storage medium of claim 17, wherein the promotional campaign contains content created by the content creator.

21. The non-transitory computer readable storage medium of claim 17, wherein the acts further comprise instructing an interface to display the message.

22. The system of claim 6, wherein the at least one of a suggested content or a suggested alteration are provided based on a previous acceptance by the creator of the content of a previously suggested alteration.

23. The system of claim 1, further comprising:
determining a time point at which a ranking associated with a messaging campaign of the subset of the plurality of messaging campaigns is below a predetermined threshold; and
in response to determining that the ranking is below the predetermined threshold, transmitting a message to the creator of content of the messaging campaign.

24. The system of claim 23, wherein the message includes a recommended change to the messaging campaign.

25. The computer readable storage medium of claim 17, wherein identifying the subset of the plurality of messaging campaigns that match the criterion of the promotion campaign is based on timing information associated with the promotion campaign.
